(19) United States
(12) Patent Application Publication
(10) Pub. No.: US 2004/0118250 A1
(43) Pub. Date: Jun. 24, 2004

(54) Safety razor

(75) Inventors: Robert White, Cholsey (GB); Graham John Simms, Reading (GB); Kevin L. Powell, Guildford (GB)

Correspondence Address: FISH & RICHARDSON PC, 225 FRANKLIN ST, BOSTON, MA, 02110, US

(73) Assignee: The Gillette Company, a Delaware corporation

(21) Appl. No.: 10/692,136

(22) Filed: Oct. 23, 2003

Related U.S. Application Data
(62) Division of application No. 09/969,495, filed on Oct. 2, 2001, now abandoned.
Application No. 09/969,495 is a continuation of application No. PCT/US00/10969, filed on Apr. 20, 2000.

(30) Foreign Application Priority Data
Apr. 23, 1999 (GB) GB 9909463.3

(51) Int. Cl. B21K 11/00; B26B 21/14

(52) U.S. Cl. 76/104.1; 30/50

(57) ABSTRACT

The invention relates to shaving and is concerned with a blade formed from a single crystal ceramic material. The blade presents a sharp cutting edge and support elements are provided for mounting and positioning the blade (cutting element) in a blade unit. A guard element is disposed forwardly of the cutting edge and extends parallel thereto. A plurality of parallel cutting elements may be provided. The invention also concerns a method of making the cutting element.

This invention is concerned with safety razors and their manufacture, and the invention is particularly concerned with the cutting elements, or blades, used in the blade units of safety razors. A safety razor generally comprises a blade unit having at least one blade with a cutting edge which is moved across the surface of the skin being shaved by means of a handle to which the blade unit is attached. The blade unit may be mounted detachably on the handle to enable the blade unit to be replaced by a fresh blade unit when the blade sharpness has diminished to an unsatisfactory level, or it may be attached permanently to the handle with the intention that the entire razor be discarded when the blade or blades have become dulled. Detachable and replaceable blade units are commonly referred to as shaving cartridges. The shaving performance of a razor blade unit is dependent not only on the sharpness of the blade(s), but on the disposition of the blade(s) in relation to other parts of the blade unit which normally contact the skin during shaving. Modern razor blade units generally have blades made from strips of steel and the manufacture of these blades can involve several steps, many of which will influence the cutting performance of the finished blade. Such manufacturing steps may include edge grinding, edge polishing, edge coating and shaping, and attachment to a blade support. The blades are assembled with other blade unit components and typically are mounted in a rectangular frame or housing which also carries guard and cap members for contacting the skin in front of and behind the blade(s). The or each blade must be set accurately in position during the assembly procedure in order to establish the desired “shaving geometry”, i.e., the precise location of the edge of the blade in relation to the skin contacting elements immediately in front and behind, as well as the angular orientation of the blade which determines the blade inclination to the skin surface during shaving. Whilst modem production techniques enable the blade manufacture and blade unit assembly operations to be automated, it will be understood that the overall blade unit manufacture is a complicated procedure requiring many operations to be performed and completed to close tolerances. Attempts have been made to improve upon stainless steel blades by manufacturing cutting elements from ceramic crystal material, namely sapphire, but the technical difficulties encountered have prevented development of any commercially acceptable alternative to steel blades.

The present invention is based on the realization that techniques employed in a technology unrelated to shaving could be used to manufacture razor blade cutting elements and could substantially simplify the production of safety razor blade units both in terms of the cutting element manufacture and in establishing the final shaving geometry which is dependent upon the blade position and orientation.

In accordance with one aspect the invention broadly resides in a cutting element in or for a safety razor blade unit, the cutting element having a sharp cutting edge and being formed integrally with supporting elements from a single crystal material.

More specifically, the present invention provides a unitary blade structure in or for a safety razor blade unit, comprising a cutting element with a sharp cutting edge, support elements for mounting and positioning the cutting element in the blade unit, and an element disposed forwardly of the cutting edge for determining shaving parameters of the cutting edge, said cutting element, support elements and further element being integrally formed from a single crystal material.

The unitary blade structure of the invention may include a plurality of cutting elements e.g., 2 or 3 cutting elements disposed one behind another with spaced cutting edges, a more forward cutting element contributing to the determination of the shaving parameters of a following cutting element. The cutting elements may be elongate and may extend essentially continuously over a major part of the length of the blade unit and can be interconnected by integral supporting elements disposed at the ends of the cutting elements. Alternatively, or in addition, integral elements can be formed to interconnect the cutting elements at one or more locations intermediate their ends. It is also possible for the unitary blade structure to include a relatively large number of cutting elements with these elements being distributed in the lengthwise direction of the blade unit as well as in the front to rear direction. Adjoining cutting elements in the lengthwise direction can then be interconnected through support elements integral with those cutting elements. In a preferred construction the blade structure of the invention includes a guard element which extends parallel to a cutting element and spaced forwardly from the cutting edge thereof. The integral guard element can form a so-called “backstop” in the assembled blade unit and hence constitutes the last part of the blade unit to contact the skin before it encounters the cutting edge of the following blade, the guard element then serving to at least participate in establishing certain parameters of the shaving geometry, most notably the span and exposure of the following blade, and to do so from the time of manufacture of the blade structure so that assembly tolerances become less critical than with conventional blade unit manufacturing methods.

Another possibility is for the blade structure to include an integral element located behind the cutting element or elements in order to form at least part of a cap structure in the assembled blade unit.

The single crystal ceramic material is conveniently silicon. Techniques for making wafers of silicon crystal and shaping such wafers have been developed in the electronics industry and are employed in the production of integrated circuits. Also, whilst the possibility to shape a silicon wafer to form a cutting edge has been appreciated, it has not been previously recognized that not only can satisfactory razor blades be made in this way, but there are very substantial advantages which can be gained by doing so in terms of simplifying overall razor blade unit manufacture. Single crystal silicon (SCS) has a number of beneficial properties which make it an attractive alternative to steel for razor blade manufacture. It has a similar elastic modulus to steel, although its strength is dependent on defect concentration within the crystal structure. A lack of grain boundaries and inclusions in integrated circuit grade SCS means that the greatest potential source of defects is surface flaws, for which reason when working on wafers of SCS care needs to be taken to minimize the risk of creating such flaws. SCS can be machined non-mechanically to dimensional tolerances less than one micrometer, which can be referred to as “micromachining”, by etching processes and then the post-processing defects are for the most part likely to be etching pits, and this should enable an SCS strength similar to steel to be achieved in the shaped SCS razor blade product. The known etching techniques include wet etching using chemicals such as potassium hydroxide, and dry etching, e.g., plasma etching and reactive ion etching, and by these techniques it has been proven that a wide range of shapes can be formed from SCS. In carrying out etching, isotropic or anisotropic etching can be used. In either case a mask is employed to establish the shape or pattern which the etching process is to produce, the mask itself being applied to the surface of the SCS by well known photolithographic techniques. With isotropic etching the removal of material occurs at the same rate in all directions, but can be controlled to produce a face substantially normal to the surface being exposed to the etching treatment, whereas anisotropic etching takes advantage of the characteristic property of the crystal material in allowing material to be removed in directions determined by the crystal structure. In SCS the {111} crystallographic planes are the slowest to be etched, so if a single crystal lying in the <001> direction is etched, the {111} planes should remain at an angle of 54.7° to the surface. This fact can be utilized to advantage in forming the razor blade cutting elements and their cutting edges in accordance with the present invention.

Whilst wet chemical etching has the advantage of being comparatively cheap and quick, the invention includes within its scope blade structure of single crystal ceramic material formed by dry etching methods which remove the crystal material by impingement with ions. The latter gives greater freedom for design, but the dry etching processes are more difficult to control and require the use of more complex and therefore more expensive equipment. Of course, blade structures can also be manufactured using a combination of wet and dry etching process, and isotropic and/or anisotropic etching may be involved.

Having regard to the foregoing it is in accordance with a second aspect of the invention that there is provided a method of making a safety razor blade unit cutting element comprising the steps of:

providing a wafer of single crystal material having a surface lying in a predetermined plane of the crystallographic structure; and

selectively removing crystal material at the surface by employing an etching process to form a planar cutting element inclined at an acute angle to the surface and having a sharp edge substantially at the surface.

As indicated above the etching process may be wet etching and/or dry etching and may be isotropic and, or anisotropic etching. The etching process can also be relied upon to form integrally with the cutting element support elements to support and position the cutting element with a safety razor blade unit.

It has been shown that the cutting edges can be formed by the etching process to have a tip radius very close to the tip radius of conventional steel blades as found in blade units currently marketed, but it may be found that other tip radii may be better suited to the cutting elements produced according to the invention. Although a sharp and reasonably hard edge may be expected from the etching process, if desired a coating of hard material, such as boron nitride, amorphous diamond or diamond-like carbon, as known per se, may be applied to the cutting edge formed from the monocrystalline material. In addition and also in a manner known per se, a coating of ptfe may be applied to the cutting edge whether or not a hard coating has been applied.

It is preferable for several unitary blade structures according to the invention to be formed simultaneously from a single wafer of monocrystalline material, with the finished individual blade structures then being separated for assembly into respective blade units.

Although as indicated above, single crystal silicon is an especially convenient and the currently preferred monocrystalline ceramic material to be employed in practicing the present invention, there are other covalently bonded single crystals which could be used to produce razor blade structures according to the invention.

The ability to determine accurately certain dimensional parameters of the shaving geometry in the final razor blade unit at the time of producing the blade and its cutting edge is a potential major breakthrough in razor blade unit manufacture and has not been previously contemplated as a possibility. The invention also opens up other development possibilities never previously available, such as the use of integrated circuit manufacturing techniques to form in situ with a blade electronic components such as sensors and/or actuators which could be utilized to control adjustments within the blade unit.

To assist a clear understanding of the invention an exemplary embodiment is described below in more detail with reference being made to the accompanying drawings in which:

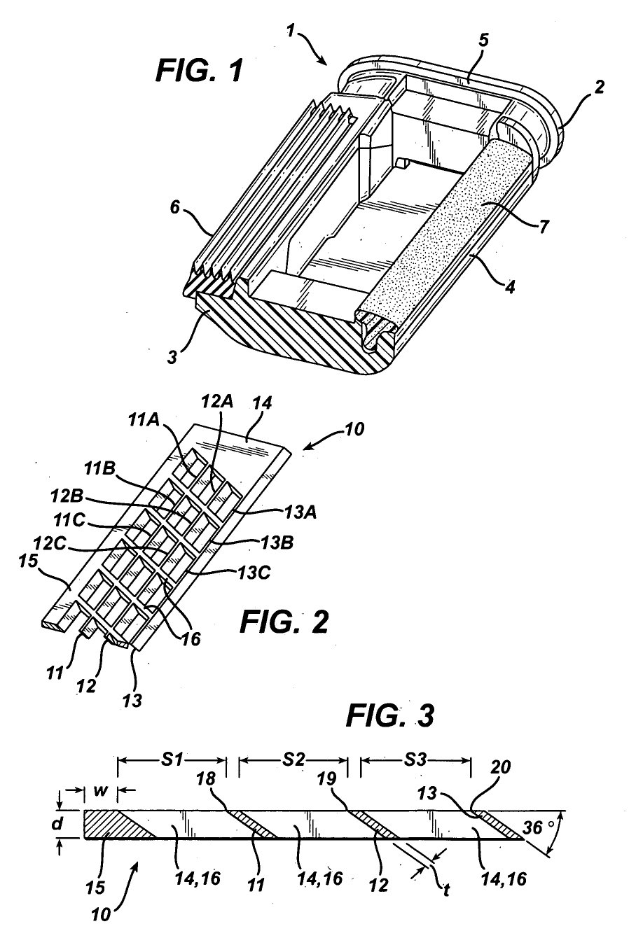

FIG. 1 shows in perspective a half sectioned blade unit housing assembly, the half not shown being in essence a mirror image of that which is illustrated;

FIG. 2 shows in perspective a half sectioned unitary blade structure according to the invention for mounting in the housing assembly of FIG. 1, the half of the blade structure not shown in the figure being essentially a mirror image of that part which is illustrated;

FIG. 3 is a cross-section through the blade structure shown in FIG. 2;

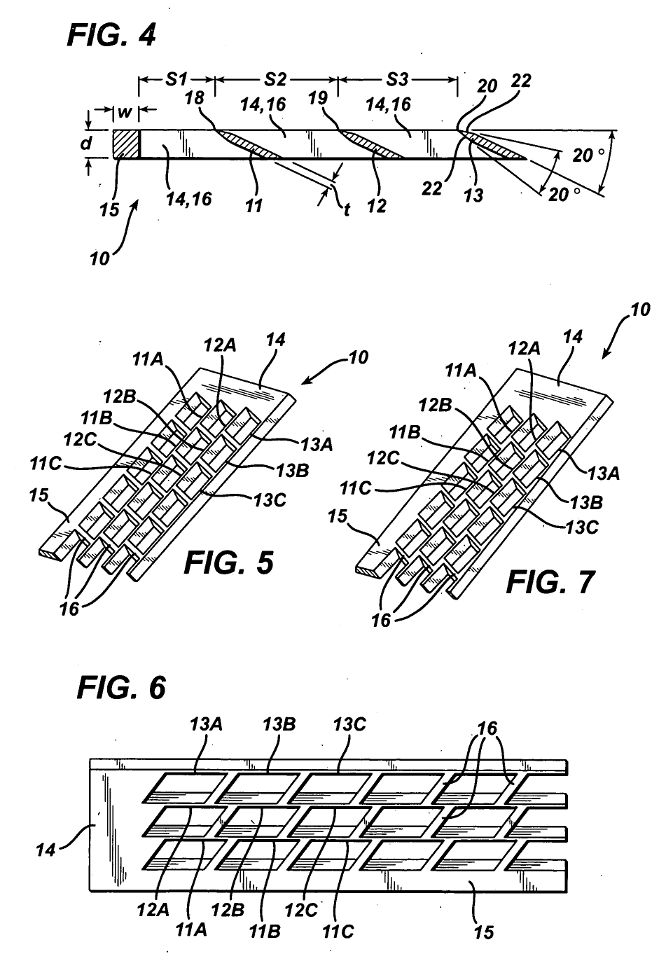

FIG. 4 is a cross-sectional view through another unitary blade structure having a different cutting edge profile;

FIG. 5 is a partial perspective view similar to FIG. 3 illustrating a modified unitary blade structure, suitable for use in the blade unit housing of FIG. 1;

FIG. 6 is a partial plan view of the unitary blade structure shown in FIG. 5;

FIG. 7 is a partial perspective view similar to FIG. 3 showing another unitary blade structure also suitable for use with the blade unit housing of FIG. 1; and

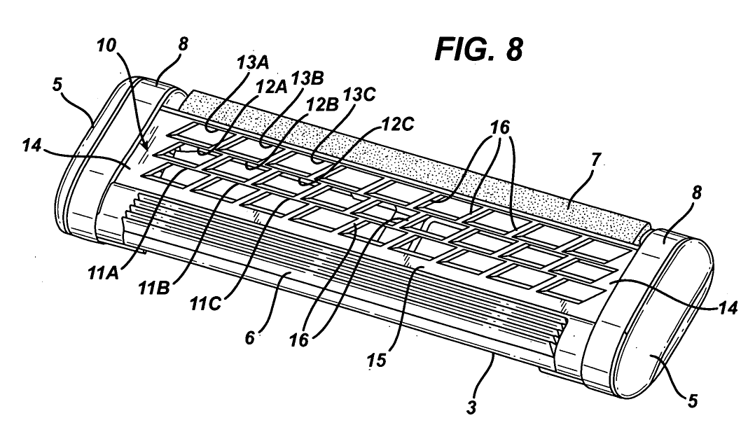

FIG. 8 is an isometric view showing an assembled cartridge incorporating the unitary blade structure of FIGS. 5 and 6.

In FIG. 1 there is illustrated a safety razor blade unit frame or housing assembly 1 which has a generally rectangular moulded plastics frame 2 with spaced parallel guard and cap members 3,4 interconnected by frame ends 5. A strip of elastomeric material 6 is carried on the guard member 3 and a shaving aid material, such as a lubricating strip 7 is carried by the cap member 4. As shown the elastomeric strip 6 is provided with upwardly directed parallel fins, but it can be differently configured as known in the art. The frame assembly 1 defines an opening in which one or more blades are to be mounted for contact with the skin between the guard and cap during shaving. As described so far the blade unit housing assembly is of a construction known previously. According to the present invention a unitary blade structure 10 formed from monocrystalline ceramic material, in particular single crystal silicon, as shown in FIGS. 2 and 3 is mounted in the blade unit frame. The blade structure 10 includes three parallel cutting elements or blades 11, 12, 13 interconnected at their ends by support elements 14 which are engageable with the frame ends 5 to mount and position the blades 11, 12, 13 within the blade unit frame. The unitary blade structure also includes a guard element or backstop 15 which is parallel to the blades and lies between the first blade 11 and the guard member 3 of the frame in the assembled blade unit so that this guard element 15 determines the span and the exposure of first blade 11. In the illustrated embodiment the blade structure 10 additionally includes transverse intermediate elements 16 interconnecting the blades and the guard element to provide additional support for the blades and/or to control the skin directly in front of the blade edges should it be desired. These transverse elements 16 are uniformly spaced along the blades so that the blade structure has an overall generally recticular form, although the transverse elements 16 do not extend perpendicularly to the blade edges due to the orientation of the crystal planes in the SCS wafer from which the blade structure is formed. The blades are forwardly and upwardly inclined and have sharp cutting edges 18, 19, 20 at their upper forwardmost extremities. The positions of the cutting edges are accurately determined in the process of manufacturing the unitary blade structure. As indicated in the exemplary embodiment of FIG. 3, the depth of the blade structure 10 is about 0.4 mm, it having been produced from a single wafer of SCS having this thickness, the minimum width w of the guard element 15 is 0.3 mm, the span S1 of the first blade 11 is 0.8 mm and span S2 and S3 of each of the second and third blades 12 ,13 is 1.5 mm. Each blade has a thickness t of 0.075 mm and is inclined at an angle of 36° to the top plane of the blade structure 10. Other dimensions are of course possible and may even prove to be desirable. The blade structure is manufactured by masking and etching a wafer of SCS, the blades at least being produced by an anisotropic etching process. With a wafer grown in the <110> direction of the crystal structure, plates to provide the blades are produced by micromachining at an angle of 36° to the wafer surface and they are formed with sharp top forward edges. However, by using a <110>wafer which has been off-oriented by 16°, it becomes possible to form the blades with the 20° inclination as shown in FIG. 4. Furthermore, facets 22 could be provided at the cutting edges by further dry etching. Thus, a desired shaving angle of the blades 11, 12, 13 may be achieved, together with other desired dimensional parameters contributing to the shaving geometry, to very high accuracy as a direct result of the micromachining process used to produce the unitary blade structure 10. Furthermore, the shaving geometry of the final blade unit may be relatively insensitive to accuracy of assembly of the blade structure 10 within the frame 1, at least in comparison with conventional blade unit constructions.

As described above, the cutting elements 11, 12, 13 have been considered to be elongate and to extend essentially continuously over substantially the full length of the unitary blade structure. It is, however, equally appropriate when the transverse elements 16 interrupt the continuity of the cutting edges, to consider each blade section 11A, 11B . . . 12A, 12B . . . 13A, 13B etc. located between the cross members constituted by the intermediate elements 16 and the end support elements 14 to be a distinct cutting element so that the unitary blade structure incorporates a large number of such cutting elements having cutting edges of short length in comparison to the length of the blade unit and distributed in the lengthwise direction of the unitary blade structure as well as in the front to rear direction thereof. In the above described embodiment of FIGS. 2 and 3, the cutting elements 11A, 12A, 13A; 11B, 12B, 13B . . . etc. which are disposed one behind the other are generally aligned in the front to rear direction, although they are offset a little due to the non-perpendicular orientation of the elements 16 with respect to the blade edges. According to the modified embodiment of FIGS. 5 and 6 corresponding cutting elements 11A, 12A, 13A; 12B, 13B . . . etc. are staggered in the longitudinal direction of the blade structure, which may be advantageous in that the cross members 16 are not aligned, that is the interconnecting elements 16 extending forwardly from each of the cutting elements is displaced along the element from the connecting elements extending rearwardly therefrom, and as a result there is greater certainty that a hair protruding from a segment of skin sliding across the interconnecting element 16 located between the cutting elements 11A and 11B, for example, will come into contact with and be cut by the cutting edge of the following cutting element 12B. Thus, the chance of hairs passing over the unitary blade structure without being cut is reduced. The unitary blade structure of FIG. 7 has similarly staggered cutting elements and interconnecting elements 16, but in this embodiment the cutting elements are inclined at a small angle, e.g., less than 10° and more particularly at about 4° to the longitudinal direction of the blade structure, which may help to reduce risk of the skin being cut should the razor blade unit be moved sideways during shaving. The unitary blade structures of FIGS. 5 to 7 each have 33 cutting elements 11A, 11B . . . , 12A, 12B . . . , 13A, 13B . . . , but a larger or smaller number could be provided as desired. FIG. 8 shows an assembled shaving cartridge with a unitary blade structure 10 as shown in FIGS. 5 and 6 assembled in a blade unit housing 1 of the form described above with reference to FIG. 1. The blade unit structure is retained in the housing by clips 8 which wrap around the housing frame 2 adjacent the end 5 and engage the end support elements 14 of the blade structure.

There are, of course, many modifications which are possible without departing from the principles of the invention. Although not included in the embodiment specifically described above, the unitary blade structure could for example include a cap element, which might be similar to the guard element, located behind the third blade 12 and interconnected with the support elements 14 and possibly with the intermediate elements 16.

1. A unitary blade structure in or for a safety razor blade unit, comprising a cutting element with a sharp cutting edge, a guard element disposed forwardly of the cutting edge and extending parallel thereto, supporting elements positioned at the opposite ends of the cutting element and interconnecting the guard element with the cutting element for mounting and positioning the cutting element in the blade unit, said cutting element, supporting elements and guard element all being integrally formed from a single crystal material.

2. A unitary blade structure in or for a safety razor blade unit, comprising a first cutting element with a sharp cutting edge, a second cutting element disposed forwardly of the cutting edge of said first cutting element and extending parallel thereto, supporting elements positioned at the opposite ends of and interconnecting the cutting elements for mounting and positioning said cutting elements in the blade unit, said cutting elements and supporting elements all being integrally formed from a single crystal material.

3. A unitary blade structure according to claim 1 or claim 2, wherein a plurality of parallel cutting elements are provided.

4. A unitary blade structure according to claim 3, wherein the cutting elements lie in respective parallel planes.

5. A unitary blade structure according to any of claims 1 to 4, including an integral cap member positioned behind the cutting element(s) and parallel thereto.

6. A unitary blade structure according to claim 1, including at least one intermediate transverse element interconnecting the cutting element and the guard element between the supporting elements.

7. A unitary blade structure according to claim 2, including at least one intermediate transverse element interconnecting the cutting elements between the supporting elements.

8. A unitary blade structure in or for a safety razor blade unit, comprising a multiplicity of cutting elements with sharp cutting edges, the cutting elements being integrally formed with each other, and with other elements interconnecting the cutting elements, from a single crystal ceramic material, said multiplicity of cutting elements being distributed along the blade structure and in the front to rear direction thereof.

9. A unitary blade structure according to claim 8, wherein two cutting elements are disposed one behind the other and have space parallel cutting edges.

10. A unitary blade structure according to claim 8 or claim 9, wherein the cutting edges of the cutting elements lie substantially in a common plane, the cutting elements are disposed in respective planes inclined to said common plane, and the interconnecting elements are spaced apart along the blade structure and extend transverse to the cutting elements and substantially parallel to the to the common plane of the cutting edges.

11. A unitary blade structure according to any one of claims 8 to 10, wherein interconnecting elements extending forwardly from a cutting element are displaced along the cutting elements from the interconnecting elements extending rearwardly therefrom.

12. A unitary blade structure according to any one of claims 8 to 11, wherein the or each cutting element is formed at least partially by anisotropic etching.

13. A unitary blade structure according to any one of claims 1 to 12, wherein the sharp cutting edge of the or each cutting element is defined by facet surfaces shaped by etching the single crystal material.

14. A unitary blade structure according to any one of claims 1 to 13, wherein the single crystal material is silicon.

15. A unitary blade structure according to any one of claims 1 to 14, wherein the cutting edge of at least one cutting element is inclined to the longitudinal direction of the blade structure.

16. A safety razor blade unit comprising a unitary blade structure as defined in any one of claims 1 to 15.

17. A method of making a cutting element for a safety razor blade unit comprising the steps of providing a wafer of single crystal material having a surface lying in a predetermined plane of the crystallographic structure, selectively removing crystal material at the surface by employing an etching process to form a planar cutting element inclined at an acute angle to the surface plane and having a sharp edge substantially at the surface plane, and forming a guard element from the wafer of single crystal material by the etching process, said guard element being disposed substantially parallel to the cutting edge and spaced forwardly therefrom and being integrally connected to the cutting element by interconnecting elements.

18. A method according to claim 17, wherein the etching process comprises anisotropic wet chemical etching.

19. A method according to claim 17 or claim 18, wherein the etching process includes dry etching.
